(19) United States
(12) Patent Application Publication
(10) Pub. No.: US 2002/0128986 A1
(43) Pub. Date: Sep. 12, 2002

(54) Communication system for franking system

(76) Inventor: Peter Stutz, Hinterkappelen (CH)

Correspondence Address: PERMAN & GREEN, 425 POST ROAD, FAIRFIELD, CT, 06430, US

(21) Appl. No.: 10/081,270

(22) Filed: Feb. 21, 2002

Related U.S. Application Data
(60) Provisional application No. 60/270,796, filed on Feb. 23, 2001.
(60) Provisional application No. 60/277,806, filed on Mar. 22, 2001.
(60) Provisional application No. 60/277,841, filed on Mar. 22, 2001.
(60) Provisional application No. 60/277,873, filed on Mar. 22, 2001.
(60) Provisional application No. 60/277,931, filed on Mar. 22, 2001.
(60) Provisional application No. 60/277,946, filed on Mar. 22, 2001.
(60) Provisional application No. 60/338,892, filed on Nov. 5, 2001.

(51) Int. Cl. G06F 17/00

(52) U.S. Cl. 705/401

(57) ABSTRACT

A method and system for franking machine communication including a franking machine, at least one peripheral device, and a bus system. The bus system includes a network controller adapted to be electrically coupled to each peripheral device and the franking machine, and adapted to permit data communications between each peripheral device and the franking machine, and between each peripheral device. A host device is associated with the network controller of the franking machine, and host device is adapted to detect and identify each peripheral device and configure the franking machine based on a state of each peripheral device. A bus is adapted to be electrically connected to each network controller for transferring data signals between the franking machine and each peripheral device, and between each peripheral device.

### CROSS-REFERENCE TO RELATED APPLICATIONS

This application claims priority of the following U.S. provisional patent applications:

serial No. 60/270,796 filed on Feb. 23, 2001,

serial No. 60/277,806 filed on Mar. 22, 2001,

serial No. 60/277,841 filed on Mar. 22, 2001,

serial No. 60/277,873 filed on Mar. 22, 2001,

serial No. 60/277,931 filed on Mar. 22, 2001,

serial No. 60/277,946 filed on Mar. 22, 2001, and

serial No. 60/338,892 filed on Nov. 5, 2001.

### BACKGROUND OF THE INVENTION

1. Field of the Invention

The present invention relates to communication systems and, more particularly, for a system for controlling information flow between peripheral devices and a franking system.

2. Brief Description of Related Developments

Franking machines often have different components based on the customers requirements. For instance, one franking machine may have a scale, while another franking machine may not. Once a franking machine is manufactured, the franking machine is not easily expanded. For instance, if a customer orders another component, such as a dynamic scale for their franking machine, it is difficult to add the component to their existing franking machine. Each franking machine peripheral device, such as the dynamic scale, needs a means for communication and data exchange with the franking machine.

Furthermore, in order to attach a peripheral device, such as a scale, to the franking machine, connecting cables for the device are connected directly to connectors on the franking machine itself. The more devices which are connected to the franking machine, the more connectors which must be available on the franking machine, and the more cables there are connected to the franking machine. These cables take up a great deal of space, and limit where the franking machine can be located. The number of connectors is defined during a franking machine design phase. It can be very difficult to add more connectors than originally planned to the franking machine.

In addition, the devices themselves are specially designed to work with the particular franking machine, making the devices expensive to manufacture and purchase. Each device also has to have special programming to communicate with the franking machine and the other devices connected to the franking machine, again increasing the cost of each device.

In addition to performing franking functions, the processor of the franking machine must be able to handle the processing of all messages sent between the devices and the franking machine. Furthermore, the processor of the franking machine must coordinate all the network functions of the devices and the franking machine itself. The processor overhead required to handle all communication and network functions either slows down the processor of the franking machine, or requires a more powerful, and more expensive, processor for the franking machine.

Moreover, for security and testing purposes, the franking machine should be aware if a device is attached or detached from the franking machine during operation of the franking machine. The franking machine should also be able to access all sensors of each of its devices for testing of the franking machine. It would be advantageous to have a communication system for a franking machine which would overcome the disadvantages of previous franking machines.

### SUMMARY OF THE INVENTION

The present invention is directed to a system for franking machine communication. In one embodiment, the system includes a franking machine, at least one peripheral device, and a bus system. The bus system includes a network controller adapted to be electrically coupled to each peripheral device and the franking machine, and adapted to permit data communications between each peripheral device and the franking machine, and between each peripheral device. A host device is associated with the network controller of the franking machine, and the host device is adapted to detect and identify each peripheral device and configure the franking machine based on a state of each peripheral device. A bus is adapted to be electrically connected to each network controller for transferring data signals between the franking machine and each peripheral device, and between each peripheral device.

In one aspect, the present invention is directed to a method for communication with peripheral devices of a franking system. In one embodiment, the method comprises providing a bus system integrated with the franking machine to communicate with each of the peripheral devices by sending and receiving data signals via the bus system, where each of the peripheral devices and the franking machine include a network controller for communicating via the bus system.

The method further includes coordinating an operation of the peripheral devices by connecting a host device associated with the network controller of the franking system to the bus system for automatically detecting the peripheral devices connected to the franking system for determining a configuration of the franking system. An operating state for each of the peripheral devices is determined by transmitting a first data signal to the peripheral devices and receiving and analyzing a second data signal from each of the peripheral devices. The method further includes transmitting and receiving the data signals directly between each of the peripheral devices.

In another aspect, the present invention is directed to a system for communication between a plurality of peripheral devices. In one embodiment, the system includes a network controller for each of the peripheral devices, with each network controller integrated with one of the peripheral devices for transmitting and receiving data signals. The system also includes a bus system adapted to be connected to each network controller and adapted to allow data signals to be transmitted between each of the peripheral devices. The network controller is associated with at least one of the peripheral devices transmits data signals to each of the other peripheral devices connected to the bus system, and the network controller is adapted to determine a state of each of the peripheral devices and a configuration of the peripheral devices.

In another aspect, the present invention is directed to a system for franking machine communication. In one embodiment, the system includes a franking machine, at least one peripheral device, and a bus system for connecting peripheral devices to a franking machine. The bus system is adapted to provide franking machine security by periodically detecting each peripheral device attached to the franking machine. The bus system includes a network controller integrated with each peripheral device and the franking machine, and adapted to permit data communications between each peripheral device and the franking machine, and between each peripheral device.

The bus system further includes a host device integrated with the network controller of the franking machine, and adapted to detect and identify each peripheral device and configure the franking machine based on a state of each peripheral device. Moreover, the bus system includes a bus adapted to be electrically connected to each network controller for transferring data signals between the franking machine and each peripheral device, and between each peripheral device.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a franking system incorporating features of the present invention.

FIG. 2 is an illustration of one embodiment of a franking system incorporating features of the present invention.

FIG. 3 is a block diagram illustrating an embodiment of states of a peripheral device of the present invention.

FIG. 4 is a block diagram illustrating an embodiment of communication data signal flow between peripheral devices and a host device of the present invention.

FIG. 5 is a block diagram illustrating data signals transmitted and received by a peripheral device in one embodiment of a system incorporating features of the present invention.

FIG. 6 is a block diagram illustrating data signals transmitted and received by a host device in one embodiment of a system incorporating features of the present invention.

FIG. 7 is a block diagram of another embodiment of a franking system incorporating features of the present invention.

### DETAILED DESCRIPTION OF THE PREFERRED EMBODIMENT(S)

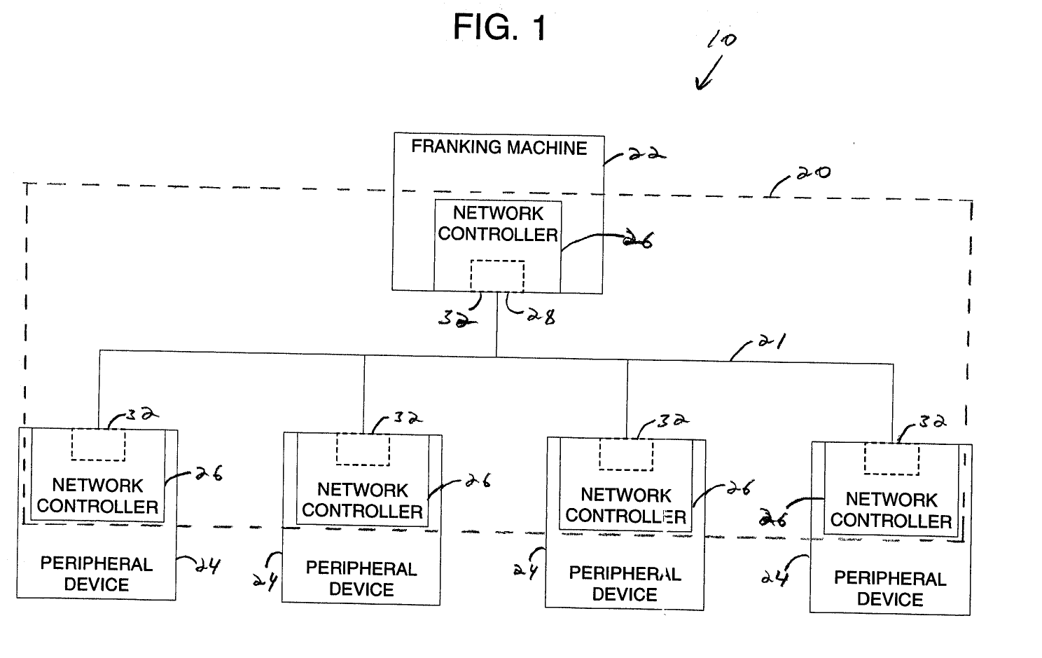

Referring to FIG. 1, there is shown a block diagram of a system 10 incorporating features of the present invention. Although the present invention will be described with reference to the embodiment shown in the drawings, it should be understood that the present invention can be embodied in many alternate forms of embodiments. In addition, any suitable size, shape or type of elements or materials could be used.

As shown in FIG. 1, the system 10 generally comprises a franking machine or device 22, at least one peripheral device 24 and a bus system 20. In alternate embodiments, the system 10 can include such other suitable components for communication between a franking machine 22 and one or more peripheral devices 24. It is a feature of the present invention to allow the franking machine 22 to be easily expanded by providing automatic configuration of peripheral devices 24 by the system 10.

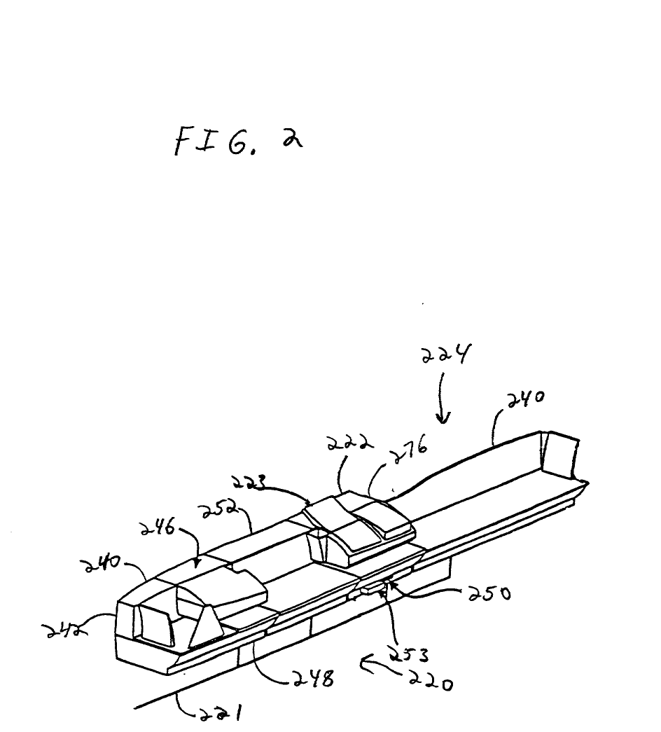

In one embodiment, referring to FIG. 1, the franking machine 22 generally comprises a device for printing postage on letters. In an alternate embodiment, the franking machine 22 can comprise any suitable device for providing a postal indicium on a workpiece. Referring to FIG. 2, in one embodiment, the franking machine 22 can include input devices 223 such as a touch screen, a keyboard and a main computer for entering or updating system data, such as entering the unique serial number for each peripheral device 24. Other input devices can include a microphone, a CD or a DVD reader, a scanner, and data input, including voice, audio and visual input, such as network, internet and intranet, without departing from the broader aspects of the present invention.

Each peripheral device 24 shown in FIG. 1 generally comprises a device for causing letter flow through the franking machine 22. The bus system 20 shown in FIG. 1 connects or couples the franking machine 22 to each peripheral device 24 and each peripheral device to each other. In one embodiment, the bus system 20 generally comprises a bus 21, a network controller 26 electrically coupled to the franking machine 22, a network controller 26 electrically coupled to each of the peripheral devices 24, and a communications system 32 included in the network controller 26 of the franking machine 22 and each network controller 26 for communication over the bus 21. In one embodiment, the communications system 32 is software included on each network controller 26. A host device 28 is included in the communications system 32 of the network controller 26 of the franking machine 22.

While the communications system has been described as software, the present invention is not so limited, as the communications system can be implemented in hardware or firmware without departing from the broader aspects of the present invention. Moreover, the communications system can be integrated with the network controllers, or be part of a device coupled to each peripheral device or franking machine. While the host device 28 has been described as software, the present invention is not so limited, as the functions of the host device 28 can be implemented in hardware or firmware, without departing from the broader aspects of the present invention. Moreover, the functions of the host device 28 could be integrated into the network controller of the franking machine, or could be part of another device coupled to the franking machine, without departing from the broader aspects of the present invention.

Continuing with FIG. 1, in an alternate embodiment, the bus system 20 can include the bus 21, the network controller 26 of each of the peripheral devices 24, and the communications system 32 without departing from the broader aspects of the present invention. In this alternate embodiment, the bus system 20 can communicate between the peripheral devices 24 without the presence or use of the peripheral device 26 of the franking machine, the host device 28, or franking machine 22. Any network controller 26 of one of the peripheral devices can perform the functions of the host device 28 associated with the network controller 26 of the franking machine 22 by including the host device 28 on the network controller 26. It is a feature of the present invention to permit each peripheral device 24 to communicate with directly with each other peripheral device 24, without the use of the network controller 26 of the franking machine 22 or the host device 28 of the franking machine 22 for communications.

In alternate embodiments, the bus system 20 can include other suitable components for allowing a franking machine 22 to communicate with or control one or more peripheral devices 24. Referring to FIG. 1, in one embodiment, the bus 21 can connect the communications system 32 included in the franking machine 22 and the communications system 32 included in each peripheral device 24. The communications system 32 can generally be a component of the network controller 26 associated with the franking machine 22 or the network controller 26 associated with each peripheral device 24. The communications system 32 associated with the franking machine 22 includes the host device 28 and is generally adapted to provide network management for the franking machine 22 and to allow the host device 28 to issue commands to the peripheral devices.

As shown in FIG. 1, the host device 28 is generally adapted to issue broadcast data signals to all the peripheral devices connected to the bus system 20. Each network controller 26 electronically coupled to each peripheral device 24 is generally adapted to communicate with the peripheral device 24 and the bus 21 and transmit and receive data signals associated with the peripheral device 24 over the bus 21.

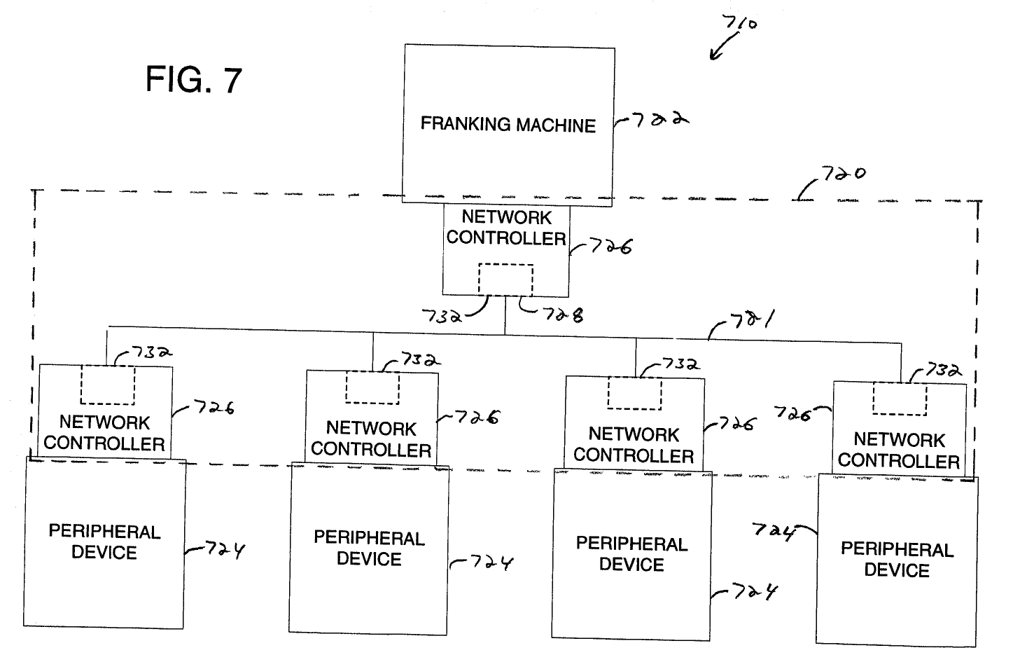

Although the host device 28 and the network controller 26 are shown in FIG. 1 as being integrated with the franking machine 22 and the peripheral device 24, respectively, it should be understood that the network controller 26 could be separate stand-alone unit or device, as shown in FIG. 7, without departing from the broader aspects of the present invention.

In one embodiment, the bus system 20 can be integrated with a franking machine 22, where integrated means electrically coupled. The bus system 20 can also be integrated with at least one peripheral device 24. While the peripheral device 24 can be a device for use in a franking or postal system, in one embodiment the peripheral device 24 is a letter handling device. While four peripheral devices 24 are shown, the present invention is not so limited, as in the present embodiment over 120 peripheral devices 24 may be integrated with the bus system 20, without departing from the broader aspects of the present invention.

Referring to FIG. 1, the peripheral devices 24 are connected directly to the bus system 20. Previously, each peripheral device 24 was separately connected to the franking machine 22. The franking machine 22 was required to have a separate connector for each peripheral device 26 to be connected to the franking machine 22. The predefined number of connectors limited the number of peripheral devices which could be connected to the franking machine. Adding more connectors required significant hardware changes to the franking machine, including expanding the size of the franking machine. The bus system 20 allows the number of connectors on the franking machine 22 to be limited without limiting the number of peripheral devices 26 connected to the franking machine 22. For example, only two connectors are needed to electrically connect the bus 21 to the franking machine 22. In one embodiment, over 100 peripheral devices 26 can be connected to the bus system 30, and the franking machine 22, without hardware changes to the franking machine 22. In another embodiment, the bus system 30 allows the connection of additional peripheral devices 26 without hardware changes to the franking machine 22.

Continuing to refer to FIG. 1, the direct connection to the bus system 20 reduces the amount of cable which formerly connected the peripheral devices 24 to the franking machine 22 itself. The reduction in cable reduces the footprint of the franking machine 22 and associated peripheral devices 24, and saves space. The connection of the peripheral devices 24 to the bus system 20 also minimizes the need for cables that would use a large amount of space in back of the franking machine 22. The space savings allow placement of the franking machine 22 in a smaller area.

Continuing with FIG. 1, the bus system 20 provides a modular approach to franking machine design so that peripheral devices can easily be added and removed. Further information which may be of interest regarding a modular franking system is included in U.S. patent application Ser. No. ______, filed on ______, entitled “Modular Franking System” for Moy, Fluckiger and Stutz, which is incorporated herein by reference. The bus system 20 provides limited plug-and-play functionality for easy configuration of the franking machine 22 which makes it easy to add or remove peripheral devices, such as a scale, to the franking machine 22. The bus system can automatically determine which peripheral devices 24 have been disconnected from the bus system 20 and which peripheral devices are coupled to the bus system 20, and configure the franking machine 22 accordingly.

Referring to FIG. 1, the bus system 20 is designed so that the host device 28 associated with the franking machine 22 can issue or transmit broadcast data signals to all the peripheral devices connected to the bus system 20. The peripheral devices 24 can also issue a broadcast data signal to the network controller 26 of the franking machine 22 and other peripheral devices connected to the bus system 20. There is no receiving address for a broadcast data signal, as the broadcast data signal is directed to all devices connected to the bus system 20.

In one embodiment, the bus system 20 includes network controllers using a Controller Area Network (CAN) bus defined by ISO 11898. CAN can be integrated into the hardware of each network controller. CAN is based on a standard shielded twisted pair terminated serial bus system 20. CAN protocol is relatively simple to implement and is widely used. CAN protocol is especially suited for networking “intelligent” devices, as well as sensors and actuators, within a system or subsystem, and is designed to transport short events. However, while the CAN bus is shown and described, the present invention is not so limited, as other bus configurations, such as ethernet or other field bus, may be used without departing from the broader aspects of the present invention.

Continuing to refer to FIG. 1, each of the peripheral devices 24 includes a device controller (not shown) on the same chip as the network controller 26. Low cost CAN chip interfaces, which implement the CAN data link layer protocol in silicon and permit simple connections to microcontrollers, are available from a number of manufacturers.

Furthermore, the bus system protocol provides automatic error checking, such as cyclic redundancy check (CRC) and retransmission of data signals, which is invisible to the franking machine main processor (not shown). In one embodiment, the bus system 20 also provides high communication speeds over short distances, such as a maximum transmission rate of 1 Mbits/sec for networks up to 40 meters in length. In another embodiment, data transmission speed depends on the properties of the cable and the speed of light. The bus system 20 for the franking machine 22 includes a two wire terminated bus 21 that up to approximately 40 meters in length has a negligible transmission time. In another embodiment, the bus 21 can be a cable that is terminated at both ends. In further embodiments, the bus 21 can be an optical bus, or a wireless bus, such as a Radio Frequency (RF) network. In one embodiment, the use of the bus system 20 reduces overhead of the main processor of the franking machine 22 by performing bus system related functions with the network controller 26 of the franking machine 22. In another embodiment, each network controller 26 handles CAN defined communication protocol, which reduces the processor load of the franking machine main processor and peripheral device processors. In a further embodiment, CAN related protocol of physical and link layers is handled by network controllers, while CANopen related protocol is handled by the main processor and the peripheral device processors. Moreover, as the peripheral devices 24 can communicate with each other directly over the bus system 20, overhead and processing demands upon the network controller 26 of the franking system 22 associated with the host device 28 are reduced.

As shown in FIG. 1, the communications system 32 for point-to-point communications between peripheral devices 24 and the franking machine 22 can be included in each network controller 26. In one embodiment, the communications system 32 used by the franking machine 22 and the bus system 20 is CANopen defined by the Can in Automation™ Association (CiA). While CANopen is shown and described, any other communications systems that allows for direct communication between network nodes and broadcast messages, such as Devicenet™ defined by Honeywell™, could be used without departing from the broader aspects of the present invention.

Referring to FIG. 1, the communications system 32 provides network management data signals and allows the host device 28 to issue commands to the peripheral devices. The communications system 32 defines a standardized format for describing peripheral devices which are capable of working with the communications system. A peripheral device profile, which contains mandatory and optional features, is defined for a specific generic peripheral device. A specific object dictionary is part of each specific peripheral device profile. The object dictionary describes the communications behavior of the peripheral device within the bus system 20, and provides an interface to the peripheral device from the bus system 20. Any peripheral device 24 which conforms to at least the mandatory features of the peripheral device profile can be included in the franking machine configuration. While a communications system having particular data formats and definitions has been shown and described, present invention is not so limited to the particular method of implementation of the communications system, as a communications system which performs the functions of the described communications system can be used without departing from the broader aspects of the present invention.

Continuing with FIG. 1, the peripheral devices 24 which work according to the peripheral device profile are exchangeable at least in regards to the mandatory features. Any peripheral device 24 which conforms to the bus system 20 standards and the communications system 32 standardized formats can be used with the franking machine 22. The peripheral devices 24 from a number of manufacturers can easily be integrated with the communication system 32 of the franking machine 22 without customized communications programming.

Continuing with FIG. 1, the automatic plug-and play type configuration of the franking machine 22 is established upon startup or reset of the franking machine 22. Upon startup, each peripheral device 24 performs its own startup tests and communicates the results to the network controller 26 of the franking machine 22 associated with the host device 28 within a predetermined time period. Each peripheral device 24 also transmits an identification data signal containing an identification code to the network controller 26 of the franking machine 22 associated with the host device 28 based on the type of peripheral device 24. Two or more identical types of peripheral devices, such as two static scales, could have the same identification code. The duplicate identification codes could cause an identification conflict, causing the franking machine and other peripheral devices to be unable to determine which of the peripheral devices put a data signal on the bus system 20. To resolve the identification conflict, each peripheral device provides access to a unique serial number signal. The serial number is provided by the manufacturer of the peripheral device.

Referring to FIG. 1, when two or more peripheral devices 24 or the network controller 26 of the franking machine 22 associated with the host device 28 attempt to transmit a data signal at the same time, priority for accessing the bus system 20 is controlled by collision sensing multiple access (CSMA) with collision avoidance. Conflict resolution of data signals and priority of data signals on the bus system 20 are determined by a data signal identifier. During transmission of a data signal, the receiver part of the network controller 26 or network controller 26 of the franking machine 22 associated with the host device 28 which is sending the data signal reads the data signal on the bus system 20 and compares the data signal with the data signal in the transmitter. If there is a mismatch, a collision has occurred on the bus system 20. The definition of CAN provides that each data signal has so called dominant and recessive bits. The dominant bits are “stronger” and they dictate the state on the bus system 20. Therefore only the network controller 26 sending a data signal which contains recessive bits in its identifier will detect a collision and stop its transmission process. Unlike Ethernet, one data signal always goes through in case of collision.

Referring to FIGS. 1, 3 and 5, the host device of the communications system 32 provides a method of node guarding which can determine whether a peripheral device 24 has detached or attached to the franking machine 22. If all the peripheral devices 24 in the franking machine configuration are not present, the bus system 20 indicates an error has occurred to the franking machine 22. In response, the franking machine 22 can shut down, or take other appropriate security violation action. In node guarding, the host device 28 periodically transmits a guarding data signal 592 to each peripheral device 24 via the bus system 20, and expects a response on the bus system 20 from each peripheral device 24 within a certain period of time. If a response is not received, the host device 28 informs the franking machine 22 that the peripheral device 24 is not responding. The type of action taken by the franking machine 22 depends upon the type of peripheral device 24. For instance, the franking machine 22 may issue a command to the device upstream of the inactive or disabled peripheral device 24 to change from an operational state 368 to an idle state 362, and stop passing workpieces, such as letters, to the inactive or disabled peripheral device 24.

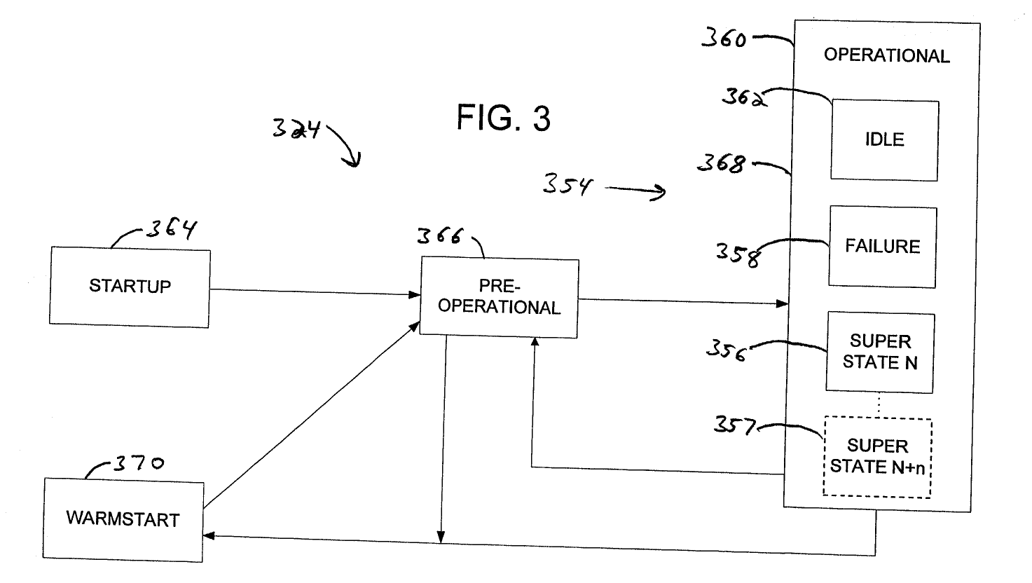

Continuing to refer to FIGS. 1 and 3, another method for ensuring security and integrity of the franking machine 22 is life guarding. In life guarding, the network controllers 26 of each of the peripheral devices 24 expect a guarding data signal from the host device of the franking machine 22 on a periodic basis. If the data signal is not received, the network controller can imply that the host device 28 and probably the franking machine 22 is not responding. In response, each peripheral device 24 can move from the operational state 368 to the idle state 362, and stop processing the letter flow. It should be noted that most of the peripheral devices are plugged directly into the franking machine 22 for electrical power. If the electrical power to the franking machine 22 fails, most of the peripheral devices will also lose electrical power, and be shut down.

The bus system 20 is scalable, that is, only the functions which are currently required for operation of the franking machine 22 need be implemented. The bus system 20 is also expandable, as additional functions can be implemented if additional functionality is required. For instance, the host device 28 can define a test state which provides access to internal actors and sensors of peripheral devices 24 for testing, diagnosis and repair.

Access by the host device 28 to the actors and sensors of the peripheral devices can occur only while the peripheral device 24 is in the test state.

As shown in FIG. 2, the peripheral devices 224 which can be coupled to the bus system 220 of the franking machine 222 can include letter handling peripheral devices, such as a feeder/sealer device 240, a front guide 242, and a stacker 244. Further information regarding letter handling peripheral devices 24 which may be of interest is included in U.S. patent application Ser. No. ______, filed on ______, entitled “Letter Flow Controls” for Moy, Stutz and Jaeger, which is incorporated herein by reference. Further information which may be of interest regarding the feeder/sealer device 240 is included in U.S. patent application Ser. No. ______, filed on ______, entitled “Separator” for Jaeger, Etter and Gasser, and U.S. Pat. No. ______, filed on ______, entitled “Letter Moistener” for Saurer, Etter and Gasser, which applications are incorporated herein by reference. Further information which may be of interest regarding the stacker 244 is included in U.S. patent application Ser. No. ______, filed on ______, entitled “Stacker” for Jaeger, Etter and Gasser, which is incorporated herein by reference.

Referring to FIG. 2, examples of other peripheral devices which can be attached to the franking machine 222 via the bus system 220 can include a static weighing scale 246, a stand 248 for the static weighing scale 246, an addressing module 276, and a dynamic scale 252 for determining an accurate thickness of mail pieces to calculate the different postage to be applied. The franking machine can also include a postal security device 253 and a rate calculation card (RCM) 250.

Continuing with FIG. 2, each of the peripheral devices 224 can be connected to the franking machine by being connected with the bus system 220. A bus 221 can be connected to the peripheral device 224 using an 8 pin RJ45 connector with ground shield. However, any other method of connecting a bus to a device may also be used without departing from the broader aspects of the present invention. As shown in FIG. 2, in one embodiment the bus 221 can be located outside the casing of the franking machine 222 and the peripheral devices 224. The present invention is not so limited, as the bus 221 can be located in back of the franking machine and/or peripheral devices 224. The bus 221 can be located within the casing of the franking machine 222 and/or peripheral devices 224, or the bus 221 can be accessed via an adapter card in each peripheral device 224. Furthermore, the bus 221 can be accessed via an adapter card which electronically couples together each peripheral device 224 and/or the franking machine 222. Moreover, the bus 221 can be located virtually anywhere the franking machine 222 and peripheral devices 224 can access the bus 221, without departing from the broader aspects of the present invention.

As shown in FIG. 3, a state event machine representing a peripheral device 324 can have several levels of super states 354, where a single state represents a special internal or external behavior of the peripheral device 324. Certain functions of each of the peripheral devices 324 may only be available in a specific state. Some of the states for each of the peripheral devices 324 facilitate error recovery, while other states are used for testing and operations.

Continuing with FIG. 3, in order to provide maximum peripheral device availability, a malfunction in any one state of the peripheral device 324 may not affect other states of the peripheral device 324, allowing some functions of the peripheral device 324 to continue operating. For instance, the peripheral device 324 having three letter flow speeds can indicate to the host device 28 that errors are occurring during the super state representing the fastest of the letter flow speeds (SUPER STATE N 356). In response, the network controller 26 of the franking machine 22 associated with the host device 28 can transmit a command data signal to the peripheral device 324 so that the peripheral device 324 can be operated in another super state representing a slower letter flow speed (SUPER STATE N+n 357) so that the franking machine 22 can continue in operation. The network controller 26 of the franking machine 22 associated with the host device 28 also can issue specific command data signals to each of the other peripheral devices 324 to enter a state corresponding to a slower letter flow speed, so that the franking machine 22 and all peripheral devices 324 will operate at the same letter flow speed.

Referring to FIG. 3, a FAILURE state 358 is the current state if the peripheral device 324 is in an error condition which is fatal to all other super states 360 including an IDLE state 362. For the peripheral device 324 which is in the FAILURE state 358, resolving the peripheral device 324 error can involve the host device 28 of the franking machine 22 issuing a node reset command data signal. The node reset data signal will cause a startup of the peripheral device 324, an entry into a STARTUP state 364, and include initiating peripheral device-specific startup tests during a PRE-OPERATIONAL state 366. The reaction of the host device 28 to the FAILURE state 358 depends on the specific error and on the specific peripheral device 324. The peripheral device 324 will enter the IDLE state 362 of an OPERATIONAL super state 368 if the startup is successful.

Continuing with FIG. 3, the peripheral device 324 can transition to SUPER STATE N 356 when the peripheral device 324 is in the OPERATIONAL super state 368. The peripheral device 324 attempts to restart itself to clear an error by exiting from the OPERATIONAL super state 368 and from the PRE-OPERATIONAL state 366 into a WARMSTART state 370. The peripheral device 324 exits the WARMSTART state 370 and enters the PRE-OPERATIONAL state 366 to conduct the peripheral device 324 startup tests.

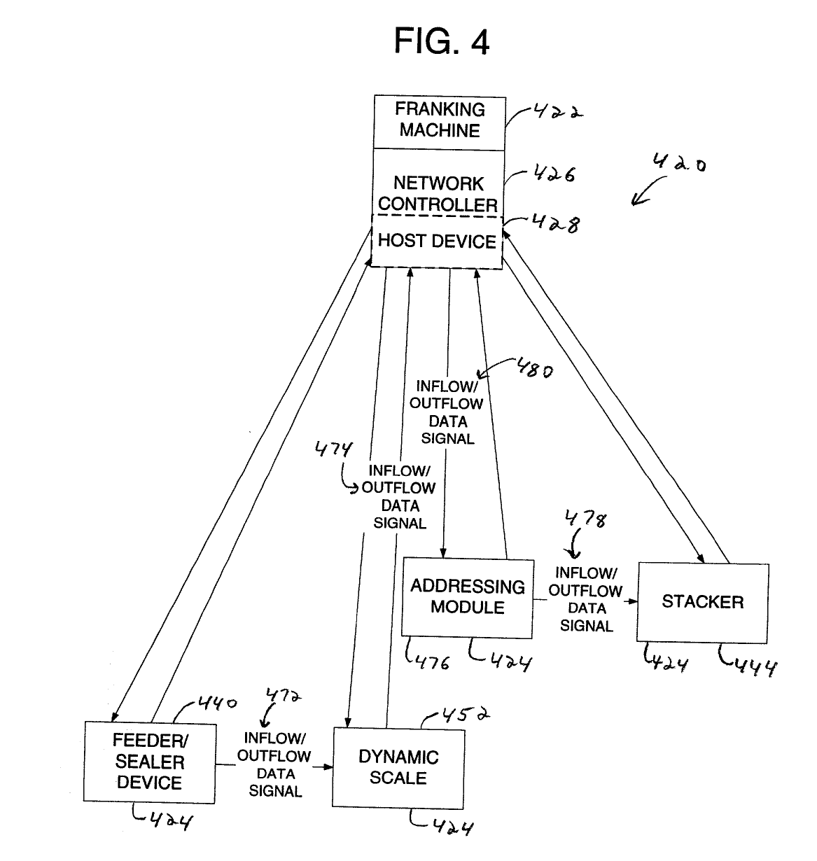

FIG. 4 shows an embodiment of communication relationships between the host device 428 of the franking machine 422 and some of the peripheral devices 424 using the bus system 420. As shown, the peripheral devices 424 can be adapted to communicate directly with other peripheral devices 424 without communicating through the network controller 26 of the franking machine 22 associated with the host device 428.

Referring to FIG. 4, in one embodiment a peripheral device such as, for example, a feeder/sealer device 440, can transmit an outflow data signal 472 directly to, for instance, a dynamic scale 452, which the dynamic scale 452 receives as an inflow data signal 472. The outflow data signal 472 is sent by the device passing on a document, and received from the previous device as an inflow data signal 472 by the receiving device. The outflow data signal 472 announces the arrival of the document in the very near future to the receiving device, such as the franking system 22 or one of the peripheral devices 26. The inflow data signal 472 is generally received from the previous device in the letter flow.

For example, the dynamic scale 452 can transmit outflow data signals 474 to the host device 428 included on the network controller 426 of the franking machine 422, as the dynamic scale 452 precedes the host device 428 in the letter flow. The data signal 474 is perceived by the host device 428 as an inflow data signal 474. The host device 428 can also transmit an outflow data signal 480 from the host device 428 to the addressing module 476, which follows the franking machine 422 in the letter flow. The data signal 480 is perceived by the addressing module 476 as an inflow data signal 480. An addressing module 476 transmits an outflow data signal 478 to a stacker 444, which the stacker 444 receives as an inflow data signal 478.

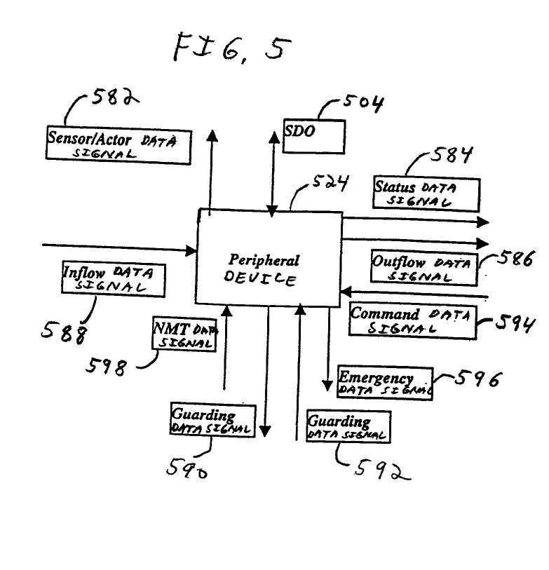

FIG. 5 shows some of the types of data signals which can be received and transmitted by a peripheral device 524. For example, the peripheral device 524 can transmit a sensor data signal 582 and/or an actor data signal 582 via the bus system 420 to the host device 428 and to other peripheral devices 524 for testing of the peripheral device 524. The peripheral device 524 can also transmit a status data signal 584 to the host device 428 and to other peripheral devices 524 for indicating a change in the operation of the peripheral devices. For instance, the status data signal 584 can be used for reporting specific events, such as a new weight, or an establishment of a new speed of the peripheral device 524 to the host device.

Continuing with FIG. 5, the outflow data signal 586 can be transmitted via the bus system 420 by the peripheral device 524 to indicate that the peripheral device 524 delivered a franking system workpiece to the following device, such as one of the peripheral devices 524 or the network controller 26 of the franking machine 22 associated with the host device 428. The inflow data signal 588 which is received by the peripheral device 524 prepares the peripheral device 524 for an arriving franking system workpiece, such as a letter. The inflow data signal 588 can be received directly from another peripheral device 524 or from the host device 428. “Arriving” and “following” refer to the location of the franking machine and the peripheral devices relative to each other and the direction of the franking machine letter flow.

As shown in FIG. 5, transmitted guarding data signals 590 and received guarding data signals 592 can be used by the peripheral device 524 and the host device 428 for implementing node guarding and life guarding. Furthermore, a command data signal 594 can be sent by the host device 428 to the peripheral device 524 to execute a specific command, i.e. shutdown. The command data signal 594 can be used for point-to-point communication with a specific peripheral device 524 or for a broadcast of a command data signal 594 to all peripheral devices 524.

Referring to FIGS. 3 and 5, an emergency data signal 596 with a predetermined error code can be transmitted by the peripheral device 524 to report an emergency condition or the resolution of a problem. In addition, the emergency data signal 596 can be transmitted whenever the peripheral device 524 changes its state to the PRE-OPERATIONAL state 366. An emergency data signal 596 with another predetermined error code can be sent by the peripheral device 524 when the peripheral device changes its state from the PRE-OPERATIONAL state 366 to the OPERATIONAL state 368.

Referring to FIGS. 4 and 5, the peripheral device 524 can receive a network management data signal command (NMT) 598, such as a Reset Node data signal, from the host device 428. The NMT data signal commands 598 can be used to initiate a state change in a peripheral device 26. Continuing with FIGS. 4 and 5, each peripheral device 524 can be configured using a service data object data signal (SDO) 504. The SDO data signal 504 is used for configuration of peripheral devices 524 and data transfer between the peripheral devices 524 and the network controller 426 of the franking machine 422 associated with the host device 428 using point-to-point communication. The SDO data signal 504 can alter a peripheral device configuration definition stored in an object dictionary. Each peripheral device 524 is set to an OPERATIONAL state 368 by receipt of the NMT data signal 598, such as “start”. The emergency data signal 596 indicates to the host device 428 that the peripheral device 524 has completed the state change.

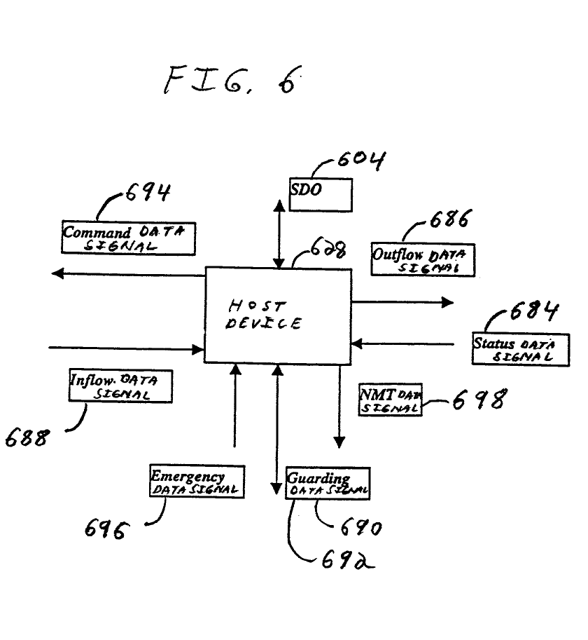

As shown in FIG. 6, in one embodiment the host device 628 can transmit a command data signal 694 to specific or all peripheral devices 424. The host device 628 can also transmit and receive guarding data signals 690, 692 for implementing node guarding and life guarding for determining whether a peripheral device 424 has detached or attached to the franking machine 422. Another data signal which can be placed on the bus system 20 by the host device 628 includes an outflow data signal 686, which indicates that the host device 628 has delivered a franking system workpiece to the following peripheral device 424. An inflow data signal 688 received by the host device 628 prepares the host device 628 for an arriving franking system workpiece, such as a letter. The inflow data signal 688 can be received directly from a peripheral device 424.

Continuing with FIG. 6, a status data signal 684 received by the host device 628 can indicate a change in the operation of one of the peripheral devices 428. For instance, the status data signal 584 can be used for receiving a report of specific events, such as an establishment of a new speed of the peripheral device 524. The receipt of an emergency data signal 696 by the host device 628 can indicate an emergency condition or the resolution of a problem by the peripheral device 428. The emergency data signal 596 can also indicate a change of state for the peripheral device 524.

As shown in FIG. 6, a network management (NMT) data signal 698 can be transmitted over the bus system 20 by the host device 628 to change the state of the peripheral device 428. Moreover, a service data object (SDO) data signal 604 can be transmitted by the host device for configuration of peripheral devices 524. The SDO data signal 504 can alter a peripheral device configuration definition stored in the object dictionary. The SDO data signal 604 can also be used for data transfer between the peripheral devices 524 and the host device 428 using point-to-point communication.

The bus system 20 allows the franking machine 22 to be easily expanded with a limited plug-and-play configuration, and allows for expansion with devices made from standard parts. The bus system 20 also removes the need to reserve space for most cables and connectors on the franking machine, and allows the franking machine to be located in a smaller area. The communication system 32 associated with the bus system 20 manages communications between the franking machine 22 and peripheral devices 24 without generating overhead for the main processor of the franking machine 22. In addition, the host device 28 of the franking machine 22 allows for testing the franking machine 22 by providing access to sensors and actuators of the peripheral devices 24. Furthermore, the bus system 20 provides security by periodically determining which of the peripheral devices 24 are attached to the franking machine 22.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A system for franking machine communication, comprising:
a franking machine;
at least one peripheral device; and
a bus system comprising
a network controller adapted to be electrically coupled to each peripheral device and the franking machine, and adapted to permit data communications between each peripheral device and the franking machine, and between each peripheral device;
a host device associated with the network controller of the franking machine, the host device adapted to detect and identify each peripheral device and configure the franking machine based on a state of each peripheral device; and
a bus adapted to be electrically connected to each network controller for transferring data signals between the franking machine and each peripheral device, and between each peripheral device.

2. The system of claim 1, wherein the bus system further comprises a two wire terminated bus.

3. The system of claim 1, wherein the peripheral devices have broadcast data transmission capability.

4. The system of claim 1, further including a communications system included on the network controller of each of the peripheral devices and the franking machine, wherein the communications system associated with the franking machine includes the host device.

5. The system of claim 1, wherein the peripheral devices include letter handling peripheral devices.

6. The system of claim 1, wherein the data signals transmitted by each of the peripheral devices include sensor data signals indicating an operating state of each of the peripheral devices.

7. The system of claim 1, wherein the peripheral devices are a feeder, a front guide or a stacker.

8. The system of claim 1, wherein the peripheral devices are a static weighing scale, a stand for a static scale, an addressing module, or a dynamic scale.

9. The system of claim 1, wherein the bus system is adapted to be expandable, modular and open for addition or removal of peripheral devices.

10. The system of claim 1, wherein the peripheral devices are connected directly to the bus system for minimizing a footprint of the franking machine and the associated peripheral devices.

11. The system of claim 1, wherein the bus is a wireless bus for wireless communication between the franking machine and each peripheral device, and between each peripheral device.

12. The system of claim 1, wherein the network controller permits data signal communications directly between each the peripheral devices without processing of the data signals by the host device.

13. A method for communication with peripheral devices of a franking machine, comprising the steps of:
providing a bus system integrated with the franking machine adapted to allow the franking machine to communicate with each of the peripheral devices by sending and receiving data signals via the bus system, wherein each of the peripheral devices and the franking machine include a network controller for communicating via the bus system;
coordinating an operation of the peripheral devices by connecting a host device associated with the network controller of the franking machine to the bus system for:
automatically detecting the peripheral devices connected to the franking system for determining a configuration of the franking system;
determining an operating state for each of the peripheral devices by transmitting a first data signal to the peripheral devices, and receiving and analyzing a second data signal from each of the peripheral devices; and
permitting data signal communications directly between each of the peripheral devices.

14. The method of claim 13, wherein the step of coordinating the operation of the peripheral devices further includes the host device broadcasting the command data signal to all of the peripheral devices.

15. The method of claim 13, wherein in the step of automatically detecting the peripheral devices coupled to the franking system, the step includes automatically receiving an identification data signal from each of the peripheral devices connected to the bus system.

16. The method of claim 15, wherein in the step of automatically detecting the peripheral devices connected to the franking system, the step further includes distinguishing between each identification data signal from each of the peripheral devices even if two or more of the peripheral devices have the same identification data signal, for determining which of the peripheral devices output a data signal to the bus system.

17. The method of claim 16, wherein the step of automatically detecting the peripheral devices connected to the franking system further includes the step of each peripheral device transmitting a unique serial number signal for uniquely identifying each peripheral device.

18. The method of claim 13, further including the steps of:
automatically detecting a disconnection of each of the peripheral devices from the bus system; and
reconfiguring the franking system based on the peripheral devices in communication with the franking system.

19. The method of claim 13, further including steps of receiving a status data signal from each of the peripheral devices for indicating a change in the operation of the peripheral devices, wherein the transmitting and receiving of the status data signals can be processed without requiring use of a main processor of the franking machine.

20. The method of claim 13, further including the step of establishing a test state for each of the peripheral devices which permits access to sensors and actors of each of the peripheral devices for testing of each peripheral device.

21. The method of claim 13, wherein in the step of providing the bus system integrated with the franking machine, the peripheral devices are letter handling devices.

22. The method of claim 13, wherein in the step of transmitting and receiving the data signals directly between each of the peripheral devices the data signals are not processed by the host device.

23. The method of claim 13, wherein the step of coordinating an operation of the peripheral devices by connecting a host device associated with the network controller of the franking machine to the bus system further includes the step of associating a communications system on the network controller of each of the peripheral devices and the franking machine, wherein the communications system associated with the franking machine includes the host device.

24. A system for communication between a plurality of peripheral devices, comprising:
at least one peripheral device;
a bus system adapted to be connected to each peripheral device and allow data signals to be transmitted between each of the peripheral devices, comprising
a network controller for each of the peripheral devices, each network controller integrated with one of the peripheral devices for transmitting and receiving data signals; and
wherein the network controller associated with at least one of the peripheral devices transmits data signals to each of the other peripheral devices connected to the bus system, and the network controller is adapted to determine a state of each of the peripheral devices and a configuration of the peripheral devices.

25. The system of claim 24, further including a communications system associated with each network controller, wherein the communications system for at least one of the peripheral devices is adapted to automatically detect and identify the peripheral devices connected to the bus system by requesting and receiving an identification data signal transmitted by each of the peripheral devices.

26. The system of claim 24, wherein the bus system provides a standard configuration for connecting the peripheral devices to the bus system.

27. A system for franking machine communication, comprising:
a franking machine;
at least one peripheral device; and
a bus system for connecting peripheral devices to a franking machine, wherein the bus system is adapted to provide franking machine security by periodically detecting each peripheral device attached to the franking machine, the bus system comprising
a network controller integrated with each peripheral device and the franking machine, and adapted to permit data communications between each peripheral device and the franking machine, and between each peripheral device;
a host device integrated with the network controller of the franking machine, and adapted to detect and identify each peripheral device and configure the franking machine based on a state of each peripheral device; and
a bus adapted to be electrically connected to each network controller for transferring data signals between the franking machine and each peripheral device, and between each peripheral device.

28. The system of claim 27, wherein the host device determines an occurrence of an error condition if the peripheral device is detached from the franking machine configuration.

29. The system of claim 27, further including a communications system included on the network controller of each of the peripheral devices and the franking machine, wherein the communications system associated with the franking machine includes the host device.

30. The system of claim 27, wherein the bus system allows the connection of additional peripheral devices without hardware changes to the franking machine.
